(19) United States
(12) Patent Application Publication
(10) Pub. No.: US 2011/0108608 A1
(43) Pub. Date: May 12, 2011

(54) METHOD FOR PRODUCING AN ALUMINUM COMPOSITE MATERIAL

(76) Inventor: Stefan Kästner, Aachen (DE)

(21) Appl. No.: 13/009,080

(22) Filed: Jan. 19, 2011

Related U.S. Application Data
(63) Continuation of application No. 10/019,706, filed on May 1, 2002, now abandoned.

(30) Foreign Application Priority Data
Jun. 30, 1999 (DE) 19929814.9
May 10, 2000 (EP) PCT/EP00/04148

(51) Int. Cl. B23K 31/02

(52) U.S. Cl. 228/116; 228/117

(57) ABSTRACT

The invention relates to a method for producing an aluminum composite material in which a cladding sheet is placed at least onto one side of a core ingot, and in which the core ingot with cladding sheets in place is subjected to several roll passes, as well as a method for producing cladding sheets from an ingot. According to the invention, known methods are simplified and improved in that the cladding sheets are cut off an ingot.

### CROSS-REFERENCE TO RELATED APPLICATIONS

This application is a continuation of prior application Ser. No. 10/019,706, filed on Dec. 27, 2001, which is a national phase application of international application no. PCT/EP00/04148 filed on May 10, 2000, which claims the benefit of and priority to German application serial No. 19929814.9 filed on Jun. 30, 1999, the entire contents of all of which are incorporated herein by reference in their entirety.

### BACKGROUND OF THE INVENTION

The invention relates to a method for producing an aluminum composite material in which a cladding sheet is placed onto at least one side of a core ingot, and in which the core ingot with cladding sheets in place, is subjected to several roll passes. Furthermore, the invention relates to a method for producing cladding sheets from an ingot.

The production of aluminum composite materials including at least two different aluminum materials (i.e., two different aluminum alloys) is particularly advantageous for various applications or it makes it possible to use aluminum materials for particular represents a method for producing aluminum composite materials which makes it possible in a simple way to produce large quantities of aluminum composite strip or foil.

The actual cladding by rolling takes place in several steps, wherein the deformability during rolling depends on the particular material. If the limit of deformability is reached, the rolling process has to be interrupted and renewed heating, to the rolling temperature (above the recrystallization threshold), has to be carried out. The ingot thickness as a starting format for hot rolling is selected such that even when thick sheets are rolled, the best possible kneading of the cast structure is achieved. The higher the material is alloyed and the lower the temperature during the last pass of the rolling material being rolled, the higher the hardening remaining in the material. In the case of plates or sheets intended for cladding by rolling, this may under certain circumstances lead to difficulties if these products do not achieve the specified strength values in the hot-rolling state on the available roll stands. Cladding by rolling takes place approximately at temperatures of 250° C. to 400° C. without intermediate annealing, with a lubricant including rolling oil, rolling emulsion or a mixture of rolling oil and rolling emulsion.

By producing aluminum composite materials, the properties of different aluminum materials can be combined in an optimal way. Thus for example, cladding of high-strength aluminum alloys with particularly corrosion-resistant aluminum alloys results in an aluminum composite material in which the core material provides the required strength values while at the same time the cladding material provides a surface with very good corrosion resistance which the core material could not provide because it is optimized with regard to the required strength. Furthermore, cladding makes it possible to produce an aluminum composite material with a melting point of its core material of, for example, 650° C., while the melting point of the cladding material is, for example, 620° C. Components from such aluminum composite materials can now be interconnected in that the components are heated in a specific way to approximately 630° C. As a result, the cladding layer melts on and ensures a coherent connection with the adjoining component.

From the state of the art it is known to produce cladding sheets or plates (for the sake of simplicity, hereinafter mostly called “sheets”) for use in a generic method for producing an aluminum composite material in that a rolling ingot made of the cladding material is rolled down to the desired thickness on a hot roll. From the strip obtained in this way, plates for placement onto the core ingot are then cut off and placed onto the core ingot. Then this composite is subjected to cladding by rolling.

In this conventional method for producing an aluminum material there is a problem in that the production of cladding sheets on the hot roll is very time consuming. Such time extensive use of the hot roll for the production of cladding sheets is problematic from the point of view of optimized work processes in the rolling mill. At the same time, due to the principle of process, the parallel arrangement of cladding sheets made by rolling is poor. This results in uneven cladding which means that thicker plating sheets must be used than would be adequate with optimal plane-parallel arrangement, so as to ensure the necessary safety reserves. Furthermore, again due to inherent factors, only cladding sheets of the same thickness can be produced during the rolling process. This not only leads to increased storage expenditure for cladding sheets which are not yet used, but it also leads to increased production costs because the production of cladding sheets of different thickness means that several ingots made from the cladding material have to be subjected to a rolling process. Lastly, the surfaces of the cladding sheets produced by rolling must be subjected to an expensive mechanical and chemical pre-treatment prior to rolling, so as to ensure impeccable connectability between the core ingot and the cladding sheets as a result of cladding by rolling.

### SUMMARY OF THE INVENTION

It is the object of the present invention to provide a method for producing an aluminum composite material or a method for producing cladding sheets from an ingot which significantly simplifies the known processes and, in addition, makes it possible to use cladding sheets with improved properties.

### BRIEF DESCRIPTION OF THE DRAWINGS

FIG. 1 shows a core ingot and two cladding sheets for use in a method for producing an aluminum composite material; and

FIG. 2 shows an embodiment of an ingot from which a cladding sheet is being cut.

### DETAILED DESCRIPTION OF THE INVENTION

According to a first teaching of the invention relating to a method for producing an aluminum composite material, the object explained and shown above is met in that the cladding sheets are cut off an ingot. By no longer obtaining the cladding sheets by rolling them from an ingot made of cladding material, as has been the case up to now with the state of the art, but instead, by directly cutting said cladding sheets from the ingot, there are a number of advantages when producing aluminum composite materials. First of all, it is now also possible to produce cladding sheets of different thickness from one ingot. This will considerably simplify production and storage. Furthermore, with the process according to the invention, the precise number of cladding sheets required can be produced from the initial ingot without any special expenditure. The time consuming hot rolling of the ingot from the cladding material is dropped out. In addition, any re-stretching of the rolled plate, which has regularly been necessary in the case of cladding sheets made by rolling, does not apply in the case of cladding sheets which are directly cut off an ingot.

By cutting the cladding sheets from the ingot by sawing, according to an embodiment of the first teaching of the invention, an excellent plane-parallel arrangement of the cladding sheets can be achieved. Such exact plane-parallel configuration brings about an optimization potential concerning the necessary thickness of the cladding sheets. Furthermore, the process of welding between cladding sheets and core ingots is considerably simplified. Finally, this results also in reduced requirements concerning surface treatment of the cladding sheets cut off the ingot by sawing. In particular, band saws are suitable for cutting cladding sheets from the ingot by sawing. With respect to ensuring plane-parallel configuration and minimum material removal, band saws are very well suited for use in the method according to the first teaching of the invention.

According to a further embodiment of the first teaching of the invention, the cladding sheets are cut off the ingot at a thickness of 2 to 100 mm. As has already been mentioned, these thicknesses can be adjusted without further ado from one cladding sheet to the other, thus providing the option of producing cladding sheets made from a single ingot for a wide range of cladding thicknesses.

Surface treatment of the core ingot and/or of the cladding sheets prior to rolling results in an optimal connection between the core material and the cladding material during the rolling process. As has already been mentioned, when compared to the requirements of cladding sheets produced by rolling, there are now significantly reduced requirements concerning surface treatment of the cladding sheets which have, for example, been obtained by being cut off the ingot by sawing. This applies particularly with regard to chemical surface treatment.

According to a second teaching of the invention, the above-mentioned object for a method for producing cladding sheets from an ingot is met in that the cladding sheets are cut off an ingot. Of course, the advantages according to the invention also apply to the method, irrespective of the actual production method for an aluminum material, according to the second teaching of the invention, for producing cladding sheets from an ingot consisting of cladding material. The advantages of arranging a method for producing an aluminum material according to the first teaching of the invention can thus be transferred without further ado to a method for producing cladding sheets from an ingot according to the second teaching of the invention.

There are a multitude of options for arranging and improving the teachings according to the invention. To this effect we refer, for example, to the description below and to the preferred embodiments that are described in conjunction with the drawings. A first example of the invention includes a method for producing an aluminum composite material in which a cladding sheet is placed at least onto one side of a core ingot, and in which the core ingot with cladding sheets in place is subjected to several roll passes characterized in that the cladding sheets are cut off an ingot. The method may include one or more of the following features: that the cladding sheets are cut off the ingot by sawing; that the cladding sheets are cut off the ingot at a thickness of 2 to 100 mm; that the core ingot and/or the cladding sheets are surface treated prior to rolling. A second example of the invention is a method for producing cladding sheets from an ingot, in particular for use in a method for producing an aluminum composite material in which a cladding sheet is placed at least onto one side of a core ingot, and in which the core ingot with cladding sheets in place is subjected to several roll passes, characterized in that the cladding sheets are cut off an ingot. The method for producing cladding sheets may be characterized by one or more of the features described in connection with the first example.

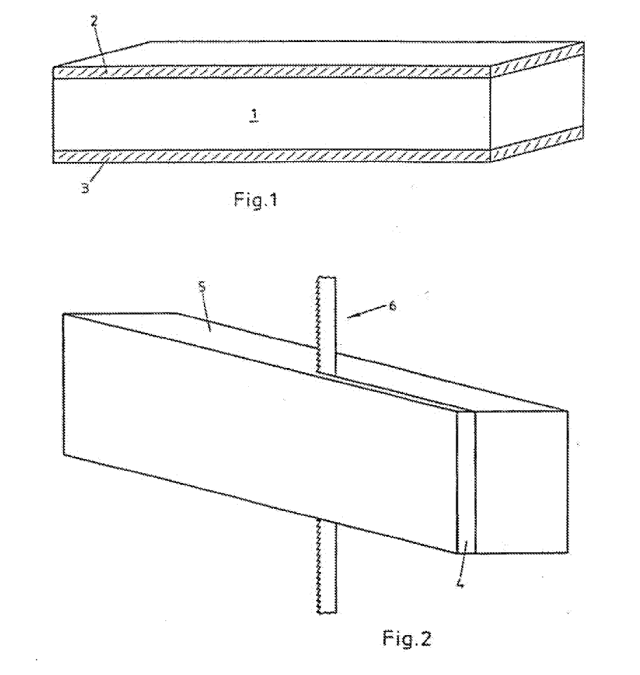

In the embodiment shown in FIG. 1, a composite material includes core ingot 1 and a cladding sheet (2, 3) both at the top and at the bottom. The materials of the cladding sheets (2, 3) are, for example, corrosion-resistant aluminum materials, while the material of the core ingot 1 features high strength.

FIG. 2 shows the production of a cladding sheet 4 made from an ingot 5 including the cladding material, by means of a band saw 6. For example, a band saw is arranged in front of a roll stand, said band saw cutting the rolling ingot in a longitudinal direction into several cladding sheets, with the cut off cladding sheets being transported on a roller table connected directly to the core ingot. FIG. 2 shows that the method according to the invention makes it possible without further ado to cut cladding sheets 4 of different thickness and of exact plane-parallel configurations into the required number of plates.

What is claimed is:

1. A method for producing an aluminum composite material, comprising:
sawing at least one cladding layer of a specified thickness suitable for use as a cladding layer from a first ingot made from a first aluminum material in a longitudinal direction;
placing said cladding layer on a side of a second ingot made from a second aluminum material; and
rolling said cladding layer and said second ingot, said rolling comprising several roll passes thereby producing said aluminum composite material.

2. The method of claim 1 wherein said sawing comprises band sawing said cladding layer from said first ingot.

3. The method of claim 2 wherein, after said sawing, said cladding layer has a thickness of 2 mm to 100 mm.

4. The method of claim 2 further comprising, prior to said rolling, treating at least one surface of said cladding layer, at least one surface of said second ingot or a combination of (a) and (b).

5. The method of claim 3 further comprising, prior to said rolling, treating at least one surface of said cladding layer, at least one surface of said second ingot or a combination of (a) and (b).

6. The method of claim 4 wherein treating comprises a chemical surface treatment.

7. The method of claim 1 wherein said cladding layer sawed from the first ingot cut has plane parallel configuration with respect to said second ingot.

8. A method for producing an aluminum composite material, comprising:
sawing at least one cladding layer having a thickness of 2 mm to 100 mm suitable for use as a cladding layer from a first ingot made from a first aluminum material in a longitudinal direction;
placing said cladding layer on a side of a second ingot made from a second aluminum material; and
rolling said cladding layer and said second ingot, said rolling comprising several roll passes thereby producing said aluminum composite material.

9. The method of claim 8 further comprising, prior to said rolling, treating at least one surface of said cladding layer, at least one surface of said second ingot or a combination of (a) and (b).

10. The method of claim 9 wherein treating comprises a chemical surface treatment.

11. The method of claim 8 wherein said cladding layer sawed from the first ingot cut has plane parallel configuration with respect to said second ingot.

12. A method for producing an aluminum composite material, comprising:
sawing at least one cladding layer of a specified thickness suitable for use as a cladding layer from a first ingot made from a first aluminum material in a longitudinal direction;
placing said cladding layer on a side of a second ingot made from a second aluminum material;
treating at least one surface of said cladding layer, at least one surface of said second ingot or a combination of (a) and (b); and
rolling said cladding layer and said second ingot, said rolling comprising several roll passes thereby producing said aluminum composite material.

13. The method of claim 12 wherein said cladding layer sawed from the first ingot cut has plane parallel configuration with respect to said second ingot.

14. A method for producing at least one aluminum cladding layer from a first ingot made from a first aluminum material, said cladding layer for use in an aluminum composite material, said composite material being produced at least partially by (1) placing said cladding layer on a side of a second ingot made from a second aluminum material, and (2) rolling said cladding layer and said second ingot, said rolling comprising several roll passes thereby producing said composite material, said method comprising sawing said aluminum cladding sheet from said first ingot in a longitudinal direction at a specified thickness suitable for use as a cladding sheet for said composite material.

15. The method of claim 14 wherein said sawing comprises band sawing said cladding layer from said first ingot.

16. The method of claim 14 wherein, after said sawing, said cladding layer has a thickness of 2 mm to 100 mm.

17. The method of claim 14 further comprising, prior to said rolling, treating at least one surface of said cladding layer.

18. The method of claim 17 wherein treating comprises a chemical surface treatment.

19. The method of claim 14 wherein said cladding layer sawed from the first ingot cut has plane parallel configuration with respect to said second ingot.
